(19) United States
(12) Patent Application Publication
(10) Pub. No.: US 2013/0078336 A1
(43) Pub. Date: Mar. 28, 2013

(54) Stabilized Edible Emulsions, Methods of Preparation, and Beverages

(71) Applicants: PepsiCo, Inc., Purchase, NY (US); University of Guelph, Guelph (CA)

(72) Inventors: Milena Corredig, Guelph (CA); Yuan Fang, Cortlandt Manor, NY (US); Valerie Massel, Milton (CA)

(73) Assignees: UNIVERSITY OF GUELPH, Guelph (CA); PEPSICO, INC., Purchase, NY (US)

(21) Appl. No.: 13/629,727

(22) Filed: Sep. 28, 2012

Related U.S. Application Data
(60) Provisional application No. 61/540,285, filed on Sep. 28, 2011.

(51) Int. Cl. A23D 7/005; A23L 2/52

(52) U.S. Cl. CPC A23D 7/0053; A23L 2/52
USPC 426/48; 426/602; 426/590; 426/72

(57) ABSTRACT

Stable, edible delivery systems for water miscible or water soluble materials, and aqueous food products such as beverages incorporating such delivery systems are provided. The disclosed delivery systems may be used to isolate a substance otherwise having an unacceptable taste in the food product or to protect a sensitive material in the food, e.g., an ingredient prone to degradation. Methods for producing the delivery systems and aqueous dispersions are also disclosed.

### PRIORITY CLAIM

This application claims the priority benefit of U.S. Provisional Patent Application Ser. No. 61/540,285, filed on Sep. 28, 2011, titled “Stabilized Emulsions, Methods of Preparation, and Beverages,” incorporated herein by reference in its entirety.

### TECHNICAL FIELD OF THE INVENTION

The present invention relates to stabilized water-in-oil edible emulsions and to methods of making them and to their use as a water-oil-water dispersion, e.g. beverages having the stabilized water-in-oil edible emulsions dispersed therein.

### BACKGROUND OF THE INVENTION

Certain edible hydrophilic substances, e.g. water miscible or water soluble materials, are desirable as ingredients in aqueous food products, such as, for example, in beverages, syrups, etc. It has been known to incorporate such substances directly into a beverage, but some such do not have an acceptable taste or taste profile as an ingredient in certain food products. Also, some such ingredients are not sufficiently stable to degradation in the intended beverage, e.g., by oxidation or hydrolysis or when exposed to air, water and/or light in the intended aqueous environment, e.g., an acidic beverage. It also has been known to incorporate various hydrophilic substances into a beverage or other edible aqueous system as an emulsion, i.e., a water-in-oil emulsion or micellar dispersion, sometimes referred to as a microemulsion. The dispersion of a water-in-oil emulsion in a food product, such as a beverage, e.g., an acidic and/or carbonated beverage, often forms a water-oil-water dispersion (alternatively referred to as a secondary dispersion or a w-o-w or W/O/W dispersion). Such W/O/W dispersions often are not sufficiently stable, providing inadequate extended protection against leakage of the hydrophilic substance of the core into the aqueous medium and/or inadequate extended protection against hydrolysis, oxidation or other degradation of the hydrophilic substance(s) in the core, especially hydrophilic substances sensitive to light, heat or acidic conditions. For example, a beverage W/O/W dispersion may not adequately protect a sensitive hydrophilic material in the core of the microemulsion particles during the entire desired shelf life of the beverage.

It is desirable to provide edible emulsions suitable for use in beverages, e.g. acidic beverages, and other edible aqueous food products, which emulsions incorporate one or more hydrophilic core substances. It is desirable to provide stable water-in-oil emulsions or micellar dispersions, e.g., in a form that is shelf stable in an aqueous beverage, syrup, etc. It also is desirable to provide aqueous food products incorporating such edible compositions. At least certain of the embodiments of the new compositions disclosed here can provide extended protection or isolation for hydrophilic substances in aqueous food products suitable for consumption by a human or animal, such as beverages, syrups and/or other aqueous food products. In at least some embodiments a sensitive hydrophilic substance, i.e., a hydrophilic substance that is prone to degrade in such food or beverage, e.g. by oxidation or hydrolysis, is made stable for use in the aqueous food product, e.g. a carbonated beverage having a pH value less than pH 5.0 and in some cases less than pH 3.5, during the expected shelf life of the food product. Additional features and advantages of some or all of the stabilized nanoparticles and aqueous food products disclosed here will be apparent to those who are skilled in food technology given the benefit of the following summary and description of exemplary, non-limiting examples.

### SUMMARY

Aspects of the invention disclosed here are directed to edible delivery systems for functional hydrophilic substances, e.g., water miscible substances, aqueous mixtures of water miscible substances, and aqueous solutions of one or more water soluble materials, etc., especially, for example, functional hydrophilic substances that have an unacceptable taste and/or are sensitive to environmental factors during food production, transport and/or storage, e.g., acidity, alkalinity, elevated temperatures from heating; heating cycles (e.g., a freeze and thaw temperature cycle) or temperature extremes, reactive other ingredients of the aqueous food product, etc. Such functional hydrophilic substances may be one or more nutritional ingredients, colorants for a beverage, or any combination of such functional hydrophilic substances. Other aspects are directed to methods of making such edible delivery systems. Other aspects are directed to beverages and other food products containing one or more of such edible delivery systems. Some sensitive substances that can be protected by certain embodiments of the delivery systems disclosed here are otherwise prone to oxidation or other degradation when included as an ingredient in an aqueous food product, e.g., in a beverage or a beverage concentrate (the latter being alternatively referred to here as a syrup).

The delivery systems disclosed here isolate and/or protect or preserve the functional hydrophilic substance(s) in the inner core of a core-and-shell structure emulsion of the water-in-oil type. The delivery systems disclosed here further include edible aqueous dispersions of such water-in-oil emulsions in the nature of water-oil-water emulsions or dispersions, such as a finished beverage or a syrup or other ingredient for use in producing a finished beverage. In some embodiments the edible water-oil-water emulsions disclosed here provide the benefits of extended protection for a water soluble nutrient by isolating the water soluble nutrient from interacting with other ingredients in a beverage, i.e., by isolating it in the inner water (or aqueous) phase of a w-o-w dispersion. In some embodiments the water-oil-water emulsions disclosed here can provide the benefits of extended protection from degradation for a water soluble nutrient or food coloring agent.

In accordance with one aspect, an edible emulsion of gelled nanoparticles is provided. The emulsion particles comprise a gelled aqueous core in a hydrophobic shell, that is, they have a core-in-shell structure wherein the core comprises an edible aqueous gel of ion bridged, i.e., multivalent cation bonded or bridged pectin, e.g., calcium-bonded pectin, and the shell comprises a hydrophobic or lipid phase. The terms cation bonded pectin and cation bridged pectin, referring to embodiments employing any suitable divalent and/or trivalent cations as the multivalent ions for gelling the pectin in the core of the elusion particles, will be used interchangeably below. Similarly, the terms calcium bonded and calcium bridged, referring to particular, non-limiting embodiments employing calcium ions as the multivalent ions, will be used interchangeably below. In addition to or instead of calcium, other multivalent cations suitable in at least some embodiments of the emulsions disclosed here to gel the pectin incorporated in the elusion particle core include, for example, zinc, magnesium and divalent or trivalent iron, and any combination thereof.

The aqueous core material or composition further comprises one or more additional hydrophilic substances, i.e., the aforesaid functional hydrophilic substance(s), e.g., water miscible substances, water soluble materials, and mixtures of any of them. Such additional hydrophilic substance is secured by the gelled pectin in the core. In some embodiments, for example, the hydrophilic substance(s) may be dispersed or interspersed in the pectin gel, absorbed or adsorbed by the gel, and/or the gel may be dispersed or interspersed in the hydrophilic material(s), absorbed or adsorbed by the hydrophilic material(s). In certain embodiments the additional hydrophilic substance comprises, consists essentially of or consists of a nutritional ingredient, e.g., a nutritional substance that would have an unacceptable taste in the intended beverage or other food product if included without being encapsulated in the shell along with the multivalent cation bridged pectin (e.g., calcium-bonded pectin). As used here, a hydrophilic nutritional substance is any food grade ingredient in the core of the emulsion that is ingestible and usable as a nutrient in the body either as is or to yield a usable metabolite in the body following digestion. In certain embodiments the nutritional ingredient is a substance that if not encapsulated might be sensitive to degradation, e.g., due to environmental factors likely to be experienced during its use in food production, transport or storage. The aqueous core material further comprises one or more enzymatic hydrolyzing agents (further discussed below) for the pectin, here meaning the enzymatic hydrolyzing agent(s) in the form originally added to the aqueous core material before gelation and/or the post-gelation reaction product(s) or residue(s) of such originally added material(s).

In certain embodiments of the emulsions disclosed here, the shell or hydrophobic phase of the nanoparticles encapsulating the aqueous pectin gel, calcium-bonded pectin (e.g., pectin gelled at least in part by calcium bridging) comprises emulsifier and edible oil, for example, plant oil, e.g., vegetable oil selected from soybean oil, palm oil, corn oil, coconut oil, sunflower oil, safflower oil, and a combination of any of them. Optionally the edible emulsion may further comprise one or more additional ingredients in the core and/or in the hydrophobic phase, e.g., antioxidants, stabilizers, etc. in any suitable combination.

It should be understood that an ingredient or material said to be used or incorporated in or into the emulsions and aqueous dispersions disclosed here, in some or all cases, may have bonded or otherwise reacted or combined with another ingredient or component. Hence, the original ingredient or component referred to may have partly or entirely ceased to be present in its original form, but for convenience or to avoid confusion, the name of the original ingredient or component will still be used here. Those skilled in the art will understand that in such cases referring to the original ingredient or material is intended to mean the residue, reaction product or combined form actually found in the finished component, ingredient or food product.

In accordance with another aspect, a food product is provided, such as a beverage product, meaning, e.g., a ready to drink beverage, a beverage powder, a beverage syrup, etc. Such food products may be acidic, neutral or alkaline, and in the case of liquid beverage products may be carbonated or not. Such food products comprise an edible emulsion as disclosed above. Certain exemplary embodiments of such food products comprise a stable aqueous dispersion of an edible emulsion as described above, and in at least some cases are in the nature of a water-oil-water (w-o-w) type emulsion or dispersion. Typically, the food products disclosed here will have one or more additional ingredients. Thus, a beverage comprising an aqueous dispersion of an edible emulsion as disclosed above may have at least one additional beverage ingredient, e.g., a flavour ingredient, color, acidulant, preservative, clouding agent, carbonation, taste masking or modifying agents, and/or sweeteners (e.g., natural and/or artificial, nutritive, low-calorie and/or calorie-free, e.g., sugar, rebaudioside, etc.) or a combination of any of them.

In accordance with another aspect, a method of making an edible emulsion is provided. The methods disclosed here include providing an aqueous core mixture (referred to in some cases as the water phase or aqueous phase, regardless whether or not yet gelled) of water, pectin and a source of divalent or trivalent cations, e.g., calcium ions, zinc ions, magnesium ions, divalent or trivalent iron ions, and any combination thereof, along with the one or more functional hydrophilic substance(s), e.g., hydrophilic nutritional substance(s), to be isolated in the core either for taste reasons or to provide protection against degradation. As disclosed above, the nutritional substance(s) may be selected from water miscible substances, water soluble materials, and mixtures of any of them. An oil phase also is provided. An emulsion is formed comprising such aqueous core mixture encapsulated or isolated as the core of core-and-shell type particles in some cases referred to here as nanoparticles, emulsion particles, or micelles. Forming the emulsion comprises combining the aqueous core mixture with the oil phase. The oil phase comprises lipophilic or hydrophobic material and oil soluble (including partially or entirely soluble) surfactant or emulsifier. The combined water phase and oil phase, optionally also including other suitable ingredients, is referred to here as the emulsion mixture. The emulsion mixture can be combined and emulsified in one or multiple steps by any suitable means. For example, either can be dispersed into the other by stirring, agitating, high shear mixing, etc., or by any combination of techniques. In certain embodiments the mixture is homogenized, e.g., using a microfluidizer or other technique or equipment. The method of making an edible emulsion in accordance with this method aspect of the present disclosure further includes gelling of the encapsulated aqueous core mixture. Gelling of the aqueous core mixture proceeds in situ, that is, at least partly in the aqueous core following formation or at least partial formation of at least the water-in-oil emulsion, and in some embodiments of the water-in-oil-in-water emulsion. Gelling of the aqueous core mixture proceeds by ion bridged pectin, e.g., by calcium-bridged pectin, at least in part after (and, optionally, also in part prior to and/or during) the emulsification or encapsulation of the aqueous core mixture. Any suitable source of divalent or trivalent ions, such as calcium ions, may be used, including, e.g., CaCO₃, as an ingredient of the water phase.

Any suitable pectin or combination of pectins may be used, including, for example, pectin having a DE value of from 25% to 80%, e.g. 35% to 70%, etc. Low methoxyl pectin and/or high methoxyl pectin may be suitable in various alternative embodiments of the emulsions and methods disclosed here. In certain exemplary embodiments of the methods of making an edible emulsion disclosed here, emulsifying the emulsion mixture comprises high pressure homogenization of the emulsion mixture followed by gelling or at least further gelling of the aqueous core mixture.

In the methods of making an edible emulsion disclosed here, the aqueous core mixture is gelled wholly or in part by enzymatically hydrolyzing the pectin, e.g., enzymatically hydrolyzing the galacturonic acid methyl esters of the pectin. Accordingly, in certain such embodiments of the methods and delivery systems or other products disclosed here, the aqueous core mixture further comprises an enzyme to modify the pectin, e.g., to hydrolyze the pectin, e.g., to hydrolyze galacturonic acid methyl esters of the pectin. For example, the aqueous core mixture may comprise pectinase enzyme, e.g., pectin methyl esterase, and gelling of the encapsulated aqueous core mixture by calcium-bonded pectin is at least partially induced by enzyme cleavage of methylated esters of galacturonic acid of the pectin by the pectinase. At least some and typically most or all of the gelling of the aqueous core material in such embodiments occurs following the encapsulating of the aqueous core mixture, i.e., after combining the aqueous core material with the oil phase material to form an emulsion mixture and emulsifying the emulsion mixture, although it may start prior to emulsification.

In certain exemplary embodiments of the methods of making an edible emulsion disclosed here, the aqueous core mixture may further comprise an acidifying agent, e.g., an ingredient that gradually lowers the acidity of the aqueous core material so as to drive gelling of the core (i.e., at least some of the gelling of the core in addition to the enzymic hydrolyzing of the pectin) by gelling the pectin by cation linkages as disclosed above, e.g., by calcium linkages. Suitable acidifying agents include, for example, glucono delta-lactone. Glucono delta-lactone (GDL) is a naturally-occurring food additive (E number E575) that can be used as an acidifier in at least certain embodiments of the methods and products disclosed here. Without wishing to be bound by theory, it currently is understood that following addition of GDL to the aqueous core material to be gelled, GDL is at least partially hydrolyzed to gluconic acid, thereby gradually acidifying the aqueous core, i.e., gradually lowering the pH of the aqueous core material. Gelling of the encapsulated aqueous core mixture by ion bridging pectin, e.g., by calcium-bonding pectin in the core, is wholly or at least partially induced by such gradual acidification of the aqueous core mixture. As noted above, at least some and typically most or all of the gelling of the aqueous core material occurs following the encapsulating of the aqueous core mixture, i.e., after combining the aqueous core material with the oil phase material and then emulsification of the combined materials, although it may start prior to emulsification.

In some embodiments of the edible water-in-oil type emulsions and corresponding secondary emulsions (e.g., beverages), and of the methods of making them in accordance with this disclosure, the functional hydrophilic substance includes at least one heat-sensitive hydrophilic substance, i.e., a substance that is not substantially stable above 100° F. or that would undergo unacceptable or undesirable oxidation, hydrolysis or other degradation if heated during the making of the water-in-oil primary emulsions disclosed here. According to a significant feature and advantage of certain exemplary embodiments, the edible emulsion comprising such heat-sensitive hydrophilic substance(s), e.g., one or more heat-sensitive hydrophilic nutritional substances, is prepared without adding heat to drive gelling of the aqueous core mixture. Rather, gelling or further gelling of the aqueous core mixture in such advantageous embodiments is induced (i.e., wholly or partly caused or driven, directly or indirectly) by the above described enzymatic hydrolyzing of the pectin in the core after combining the aqueous core mixture with the oil phase and emulsifying, with or without gelling also by the above described gradual acidification of the aqueous core mixture by an acidification agent added to the aqueous core mixture. Gelling in such non-heated embodiments may be induced by such hydrolyzing of the pectin (and optionally also gradual acidification), with or without factors, ingredients or conditions other than the addition of heat, e.g., viscosity of the core mixture, its titratable acidity, etc. It should be understood that these non-heated embodiments of the products and methods disclosed here may comprise non-heat sensitive hydrophilic substances in the aqueous core mixture either in addition to or in lieu of any heat-sensitive hydrophilic substance(s), but they are especially advantageous in being able to provide water-in-oil type emulsions and water-in-oil-in-water type emulsions with one or more heat-sensitive hydrophilic substances in the aqueous core mixture, wherein heat-sensitive hydrophilic substance is completely or substantially protected against degradation in the process of producing the emulsion. A heat-sensitive hydrophilic substance is substantially protected against degradation if more than half remains un-degraded in the finished emulsion, and in some embodiments more than ninety percent (90%) of the heat-sensitive hydrophilic substance remains un-degraded in the finished emulsion. It should be understood that in the non-heated embodiments of the products and methods disclosed here, incidental heating may occur which is not excluded, for example, “heat of mixing” when the various ingredients and materials are combined, exothermic reactions when the various ingredients and materials are combined, etc. Such incidental heating is not excluded from these non-heated embodiments of the methods and products disclosed here, so long as the temperature of the heat-sensitive hydrophilic substance is not elevated by such incidental heating to a degree which would cause substantial degradation of the heat-sensitive hydrophilic substance. It is a significant advantage of these non-heated embodiments that water-in-oil type emulsions and water-in-oil-in-water type emulsions can be provided with one or more heat-sensitive hydrophilic substances in the gelled aqueous core without adding heat that would substantially degrade the heat-sensitive hydrophilic substance(s).

In certain exemplary embodiments of the delivery systems, food products and methods of making an edible emulsion disclosed here, the lipophilic material comprises edible oil, for example, plant oil, e.g., soybean oil, palm oil, coconut oil, sunflower oil, corn oil, etc., or any suitable combination of edible oils. The emulsion material further comprises an emulsifier or surface active agent, e.g., polyglycerol polyricinoleate (PGPR) and/or other suitable emulsifier(s). The emulsifier may be added to the emulsion material separately and/or as a component of the oil phase. It will be within the ability of those skilled in the art, given the benefit of this disclosure, to determine suitable amounts of the edible oils, emulsifier and all other materials used in the edible emulsions. For example, emulsifier typically can be used at a concentration between 1.0 wt. % and 10.0 wt. % of the lipophilic material.

In accordance with another aspect, methods are provided of making a stable aqueous dispersion of an edible emulsion, e.g., a beverage product. A method according to this aspect of the disclosure includes forming an emulsion mixture for a water-in-oil emulsion as disclosed above. The emulsion mixture comprises an aqueous core mixture of at least water, functional hydrophilic substance, e.g., hydrophilic nutritional substance, pectin, and a source of divalent or trivalent cations, e.g., calcium ions, with an oil phase. The emulsion mixture is formed by combining the aqueous core mixture with lipophilic material and emulsifying the combined materials. Gelling of the encapsulated aqueous core mixture is induced by formation of ion-bridged pectin, e.g., calcium-bonded pectin.

In accordance with another aspect of this disclosure, methods are provided for forming a beverage, beverage syrup (e.g., a five-plus-one throw syrup intended to be mixed with water five times its volume to yield six times its volume of finished beverage) or other aqueous food product or food ingredient. In certain embodiments such food product or food ingredient is a W/O/W emulsion or secondary emulsion. One or more edible emulsions as disclosed above are dispersed in an aqueous liquid, e.g., water containing one or more other beverage ingredients or plain water, to form a beverage or other stable aqueous food product. Alternatively, one or more edible emulsions as disclosed above are dispersed in an aqueous liquid to form a stable aqueous ingredient or intermediate product for a beverage or other food product. It will be within the ability of those skilled in the art, given the benefit of this disclosure, to determine a suitable amount of the edible emulsion to include in the aqueous food product or in the aqueous ingredient for a food product. In certain embodiments the edible emulsion is from 0.05 weight percent (wt. %) to 5.0 wt. % of an aqueous food product, e.g., from 0.1 wt. % to 1.0 wt. %, depending upon the nutritional objective to be met by the addition of the edible emulsion. In an ingredient which is a concentrate for a food product, the edible emulsion has a correspondingly higher concentration. For example, in a beverage syrup, e.g., a 1-plus-5 throw syrup to be mixed with carbonated water to form an acidic, carbonated beverage, where one part syrup is combined with 5 parts water, for a final dilution of 1 in 6, the concentration of the edible emulsion in the syrup should be six times higher than the desired concentration of the edible emulsion in the final beverage. Thus, in certain 1-plus-5 throw syrup embodiments in accordance with the present disclosure, the edible emulsion is from 0.3 wt. % to 30.0 wt. % of the syrup, e.g., from 0.6 wt. % to 6.0 wt. %, depending upon the nutritional objective to be met in the finished beverage.

In accordance with another method aspect, gelled water-in-oil type emulsions are prepared by a process comprising providing an aqueous core mixture of water, functional hydrophilic nutritional substance (as described above), pectin and a source of divalent calcium ions. The water-in-oil type emulsion is then formed, comprising encapsulating the aqueous core mixture with an oil phase comprising lipophilic or hydrophobic material. The aqueous core mixture is combined with the oil phase to form an emulsion mixture, and the emulsion mixture is emulsified, optionally by or with homogenizing at high pressure, e.g., 3000 to 4000 psi. The encapsulated aqueous core mixture is gelled, comprising formation of cation-bridged pectin in the core, e.g., calcium-bonded pectin, at least in part subsequent to the emulsification step.

At least certain embodiments of the technology disclosed here can provide good or better stability of encapsulated functional ingredients for beverages and other foods, e.g., such functional ingredients as colorants and nutritional ingredients. That is, for example, the functional ingredient can be isolated and/or protected from degradation in a beverage or other food product more completely and/or for a longer period of time. In some embodiments the emulsion particles are stable so as to remain intact, i.e., not to substantially break down or release the gelled core until they reach the stomach or the intestinal track below the stomach of the consumer. The emulsions can protect a water soluble nutrient, food color, etc. from interacting with other ingredients in a beverage base by isolating it in the gelled, inner water phase. In at least certain embodiments of the methods and products disclose here, the water phase of the emulsion is gelled without heating the emulsion mixture, that is, without providing an external or supplemental source of heat to elevate the temperature of the emulsion mixture or of the resulting emulsion. In such embodiments, providing pectin with a source of divalent or trivalent cations, e.g., calcium, in situ in the pre-gelled aqueous core material prior to encapsulation can provide significant advantages. In at least certain embodiments of the methods and products disclose here, it enables the encapsulation of heat sensitive ingredients in a gel-stabilize water-in-oil emulsion and w-o-w aqueous dispersion for beverage and other food applications, for example. These and other aspects, advantages and features of the present invention herein disclosed will become apparent through reference to the following detailed description. Furthermore, it is to be understood that the features of the various embodiments described herein are not mutually exclusive and exist in various combinations and permutations in other embodiments.

### BRIEF DESCRIPTION OF THE DRAWINGS

FIG. 1 is a graph showing the apparent radius of water in oil emulsion particles of emulsions prepared in accordance with Example 1, below, with different amounts of PGPR. Values are the average of three replicates, with bars indicating standard deviation. Apparent radius was measured over time, without dilution, using diffusing wave spectroscopy.

FIG. 2 is a graph showing the apparent radius of water in oil emulsion particles of emulsions prepared in accordance with Example 1, below, with different amounts of PGPR. Values are the average of three replicates, with bars indicating standard deviation. Apparent radius was measured over time, without dilution, using diffusing wave spectroscopy.

FIG. 3 is a pair of graphs showing results discussed in Part 2 of Example, 1, below, specifically, apparent radius measured using diffusing wave spectroscopy of water in oil emulsions containing 0.5% LMP prepared with different amounts of PGPR. Emulsions were either gelled (Graph A) with calcium carbonate and GDL or non-gelled (Graph B). Values are the average of three replicates, with bars indicating standard deviation.

FIG. 4 is a pair of graphs showing the turbidity parameters measured for the emulsions of FIG. 3, specifically, turbidity parameters measured using diffusing wave spectroscopy of water in oil emulsions containing 0.5% LMP prepared with different amounts of PGPR. Emulsions were either gelled (Graph A) with calcium carbonate and GDL or non-gelled (Graph B). Values are the average of three replicates, with bars indicating standard deviation.

FIG. 5 is a pair of graphs showing the apparent radius of emulsion particles made in Example 2, below, specifically, of the apparent radius measured using diffusing wave spectroscopy of water in oil emulsions containing 1.0 wt. % HMP prepared with 4 wt. % PGPR. Emulsions were either gelled (Graph A) with the addition of PME or non-gelled (Graph B). Values shown are the average of three replicates, with bars indicating standard deviation.

FIG. 6 is a pair of graphs showing the turbidity parameter (1/1*) values measured for the emulsions of FIG. 5, specifically, measured using diffusing wave spectroscopy of water in oil emulsions containing HMP and prepared with 4% PGPR. Emulsions were either gelled (Graph A) with the addition of PME or non-gelled (Graph B). Values are the average of three replicates, with bars indicating standard deviation.

FIG. 7 is a pair of graphs showing the apparent diameter for the emulsions of FIG. 5, specifically, of the apparent radius measured fresh, after 1 week and after 1 month of storage at refrigeration temperatures, using diffusing wave spectroscopy. Emulsions were either gelled (Graph A) with the addition of PME or non-gelled (Graph B). Values are the average of three replicates, with bars indicating standard deviation.

FIG. 8 is a pair of graphs showing particle size distribution, measured using integrated light scattering, for the emulsions of FIG. 5, specifically, of the particle size distribution measured fresh, after 1 week, and after 1 month of storage at refrigeration temperatures. Emulsions were either gelled (Graph A) with the addition of PME or non-gelled (Graph B). Values are the average of three replicates, with bars indicating standard deviation.

FIG. 9 is a graph showing the amount of brilliant blue (Erioglaucine) encapsulated in the emulsion droplets during storage (as well as after a freeze thaw cycle) for control emulsions (with no HMP) as well as HMP-containing emulsions with and without the inner core gelled. Values are the average of three replicates, with bars indicating standard deviation.

FIG. 10 shows confocal images of the emulsions of Example 3, below, containing HMP and stabilized with PGPR and sodium caseinate, after two months of storage at refrigeration temperature.

FIG. 11 shows confocal images of emulsions discussed in Example 3, below, including control emulsions (no pectin), and emulsions containing HMP without a gelled core, and emulsions containing HMP with a gelled core.

### DETAILED DESCRIPTION OF THE INVENTION

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are merely non-limiting examples of the inventive subject matter and that there are or may be other, alternative embodiments which are not excluded. Unless otherwise indicated or unless otherwise clear from the context in which it is described, alternative elements or features in the embodiments and examples below and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the devices and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited.

As used in this disclosure, unless otherwise specified, the term “added” or “combined” and like terms means that the multiple ingredients or components referred to (e.g., one or more sensitive, hydrophilic substances, pectin, etc.) are combined in any manner and in any order, with or without stirring or the like, with or without heating, etc. For example, one or more ingredients can be dissolved into one or more other ingredients, or sprayed together, etc. As used here, a material referred to as a “solution” may be a true solution, a slurry, a suspension, or other form of liquid or flowable material. In certain embodiments, for example, materials may be said to be combined to form a homogenous solution. As used here, the term “homogenous” means commercially adequately homogenous for the intended use, e.g., as a component of a next step in a process, as a stand-alone consumable or as an ingredient in a beverage or other food product, as the case may be.

As used here, a food product “comprises an emulsion” or “comprises an aqueous dispersion of an emulsion” where the food product includes one or more such emulsions, typically together with one or more other food ingredients. The food product comprises such emulsion, as that term is used here, notwithstanding that some or all of the water or other diluent or solvent and/or other component or expendable ingredient(s) that the emulsion may originally have had, are not included in the final food product. For example, some or all of the water of the emulsion may be removed prior to, during or after mixing with other ingredients of the food product. In some embodiments of the food products disclosed here, essentially all of the hydrophilic substance of the type isolated or protected by the emulsion is incorporated into the emulsion. As used here, “essentially all of the hydrophilic substance” means that the concentration or amount of the hydrophilic substance not incorporated into the emulsion is less or lower than the taste or smell threshold for most people in the food product in question. In some other embodiments the aqueous dispersion includes a perceptible concentration of the hydrophilic substance in addition to the portion incorporated into the emulsion. As used here, an aqueous dispersion comprises, consists essentially of, or consists of particles distributed throughout a medium of liquid water, e.g., as a suspension, a colloid, an emulsion, a sol, etc. The medium of liquid water may be pure water or may be a mixture of water with at least one water-miscible solvent or diluent, such as, for example, ethanol or other alcohols, propylene glycol, glycerin, etc. In some exemplary embodiments there may be a substantial concentration of water-miscible solvent in the emulsion. In other exemplary embodiments, the wax emulsion is diluted into a food product and the amount or concentration of water-miscible solvent may be negligible.

The term “pectinase” or “pectinase enzyme” is used here as a general term for enzymes that break down pectin or cleave methylated esters of galacturonic acid of the pectin, such as pectin methyl esterase, pectolyase, pectozyme, polygalacturonase and other such pectin enzymes. In certain embodiments of the emulsions, aqueous dispersions and food products disclosed here, the “hydrophilic substance” comprises, consists essentially of, or consists of a water miscible material, e.g., a water-soluble vitamin, a water-soluble sterol, a water-soluble flavonoid, mineral, extracts from plants, herbs, DNA, amino acid, water soluble organic compounds or a combination of any of them. The hydrophilic substance may be a solid in solution, a liquid or a mixture of both in the emulsions and complex coacervates disclosed here. In some embodiments the sensitive substance is a combination of water immiscible material and water soluble material.

As used here, the term “sensitive to environmental factors” with reference to a hydrophilic material in the core of the edible emulsion nanoparticles disclosed here means that the hydrophilic material would undergo a substantial or unacceptable degree of oxidation, hydrolysis and/or other degradation upon exposure or prolonged exposure to one or more environmental factors, if not protected by the emulsion nanoparticles, such as environmental factors during food production, transport or storage, e.g., high or low acidity or alkalinity (e.g., pH values below 5.0 or below 3.5 or above 8.0 or above 9.5), temperature extremes or a temperature cycle (e.g., a freeze and thaw temperature cycle or temperatures more than 15° C. above or below room temperature or more than 20° C. above or below room temperature), reactive other ingredients of the food product, etc.

As used here, the term “nutritional ingredient” with reference to a functional hydrophilic material in the core of the edible emulsion nanoparticles disclosed here means a substance such as a food ingredient (or intended for use as a food ingredient) that has nutritional value to a human or other animal, e.g., a bioactive material. Nutritional ingredients that may be incorporated into the ion-bridged pectin core, e.g., a calcium bonded pectin gel, of a nanoparticle in accordance with certain exemplary embodiments include water soluble vitamins, minerals, probiotics, etc., and combinations of any of them, e.g., ascorbic acid, ferrous lactate, magnesium oxide, zinc oxide, calcium oxide, extracts from plants, herbs or botanicals, etc.

In certain exemplary embodiments, at least a majority of the emulsion particles have a diameter, as determined by diffusing wave spectroscopy, in the range of 150 nm to 450 nm, e.g., from 200 nm to 400 nm. As used here, the “diameter” is the largest dimension of the particle, and the particle need not be perfectly spherical.

In certain exemplary embodiments of the w-o-w emulsions (water in oil in water) disclosed here containing gelled nanoparticles in the inner droplets, the amount of emulsifier, e.g., PGPR, can be adjusted to obtain stable water in oil (“w/o”) emulsions formed using a high pressure homogenizer. In certain exemplary embodiments the emulsion contains a 30% water in oil emulsion (i.e., 30 wt. % water) with droplets having a radius of 200-300 nm. The particle size and optical properties of these emulsions can be measured using dynamic light scattering, for example, using diffusing wave spectroscopy (DWS), a light scattering technique that allows for analysis of the emulsions with no dilution. Sodium caseinate or any other emulsifier optionally can be used to stabilize the secondary oil droplets. The inner water particles are gelled in situ as disclosed above.

In certain exemplary embodiments, pectin, e.g., high methoxyl pectin (HMP) and/or low methoxyl pectin (LMP), is gelled in situ in the aqueous cores of the microemulsion by enzymatically hydrolyzing the pectin, e.g., by the action of pectinesterase in the aqueous core material at least in part while and/or after the emulsion mixture is emulsified, with calcium carbonate in the aqueous core mixture. Optionally, such gelation of the core may be promoted or caused also in part by acidification, e.g., gradual acidification of the aqueous core at least in part while and/or after the emulsion mixture is emulsified. By using emulsion particles with aqueous cores gelled by enzymatically hydrolyzing pectin in the core, an extensive heat treatment step is not required for gelling in at least certain embodiments of the methods disclosed here for producing the gelled emulsions. In certain exemplary embodiments no added heat is needed or used. In certain exemplary embodiments, the emulsion is better stabilized by gelation of the core, and there is an increase in encapsulation efficiency, that is, in the effectiveness of the isolation and/or protection against degradation of a sensitive functional hydrophilic ingredient in the core. At least certain embodiments of the water in oil emulsions with a gelled core disclosed here can be used as an edible delivery system to the consumer for the delivery of hydrophilic minerals, hydrophilic vitamins or other hydrophilic nutritional ingredients of a beverage or other food product (e.g., nutraceuticals, bioactive molecules, etc.) or for the incorporation of hydrophilic food color or other hydrophilic food ingredient(s), etc. in such food products.

### EXAMPLES

Example 1: Water in oil emulsions were prepared from emulsion mixtures as described above, using a high pressure homogenizer. For comparison, otherwise identical emulsions were prepared with and without gelling of the aqueous core. First, emulsions without gelling of the aqueous core were prepared and the size and stability of the emulsion particles were measured using light scattering and by visual observations. PGPR was employed as an emulsifier in the emulsion mixtures at three different concentrations: 2 wt. %, 4 wt. % and 8 wt. %. In addition to traditional DLS, the size of the water-in-oil particles of the resulting emulsions was measured using DWS without dilution. Stability was tested as a function of time. Next, emulsions with gelled aqueous cores were prepared. Gelation within the water droplet (i.e., the aqueous core) was adjusted and compared by using 0.5 wt. % LMP or 1.0 wt. % HMP, in the presence of calcium. Whenever possible, bulk gelation was tested using rheology (in the HMP model). Integrated light scattering (Mastersizer available from Malvern Instruments Ltd.), was used to measure the size of the secondary emulsion droplets prepared with gelled and non-gelled inner cores. Confocal microscopy was employed to verify the presence of inner droplets. To study the encapsulation behavior, two compounds were used. Brilliant blue (a small molecular weight hydrophilic molecule) and MgCl2 were added to the water phase before gelation. The stability of the oil droplets and their release over time were tested using UV/ViS spectroscopy (for brilliant blue) or ion chromatography (Metrohom) for magnesium.

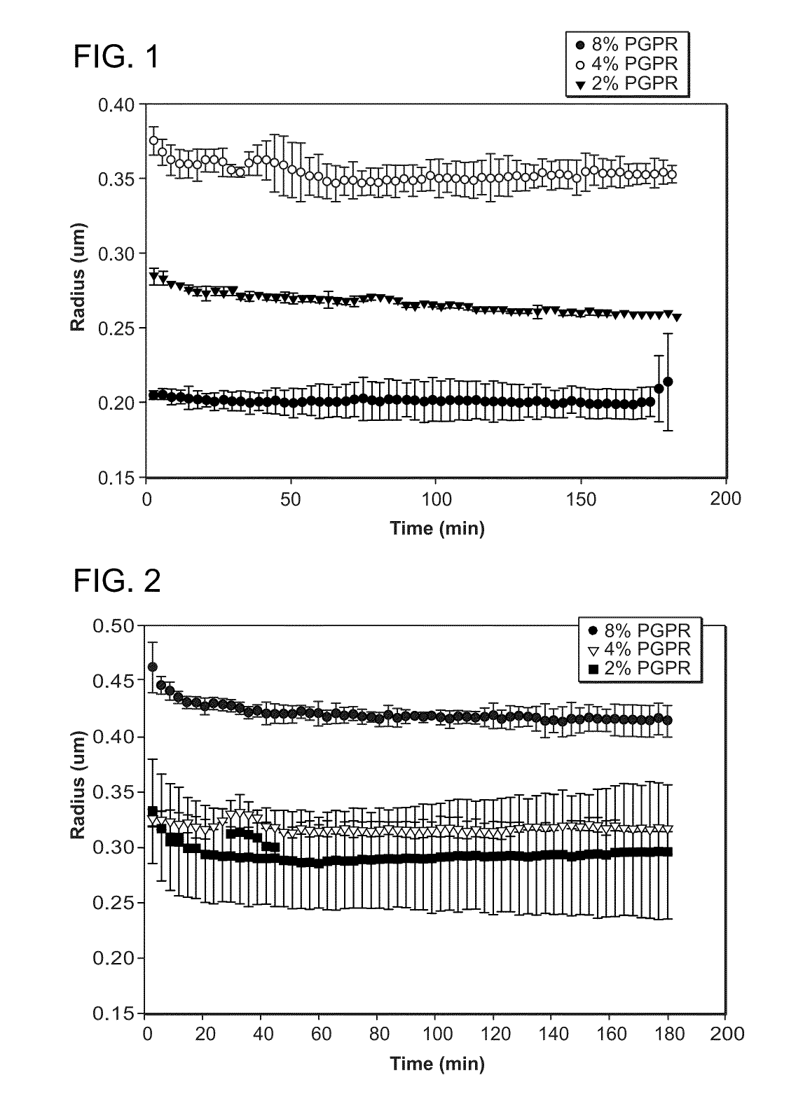

Part 1. Inverse emulsions. 30% water in oil emulsions were prepared by mixing a solution of 0.1 M NaCl with soybean oil and polyglycerol polyricinoleate (PGPR) at three concentrations: 2.0 wt. %, 4.0 wt. % and 8.0 wt. %. The emulsions were prepared using a high pressure homogenizer, and the particle size was then measured (without dilution) using diffusing wave spectroscopy. All emulsions showed stability over time, as the radius did not change during the measurement. As the analysis is very sensitive to changes in the mobility of the water droplets, it is possible to infer that these systems would be stable during processing, such as during food processing, e.g., in a process comprising combining with carbonated water a beverage syrup comprising these emulsions. FIG. 1 shows the apparent radius of emulsion particles of emulsions prepared in accordance with this example, with different amounts of PGPR. Values are the average of three replicates, with bars indicating standard deviation. Apparent radius was measured using diffusing wave spectroscopy. As seen in FIG. 1, all droplets showed a radius<400 nm, and those prepared with 8.0 wt. % PGPR showed the smallest apparent size. DLS measurements carried out under very diluted conditions in tetradecane confirmed these results.

The same emulsions were then prepared except with a 0.5 wt. % low methoxyl pectin solution (LMP, CpKelco), 0.1 M NaCl, with pH adjusted to 5.0. Again, multiple runs were prepared using different amounts of PGPR, specifically, 2.0 wt. %, 4.0 wt. % and 8.0 wt. % PGPR. FIG. 2 illustrates the apparent radius of the water in oil emulsions, measured over time, without dilution, using diffusing wave spectroscopy. In this case also, the water droplets were stable over time, although those prepared with 8.0 wt. % PGPR showed a larger particle size compared to those prepared with 2.0 wt. % and 4.0 wt. % PGPR. Without wanting to be bound by theory, it is believed that the higher apparent radius may be due to a higher amount of PGPR non-adsorbed at the interface, as DLS measurements under diluted conditions showed a size of about 300 nm. LMP may play a synergistic role in the stabilization of the emulsion droplets, and this was further supported by peripheral experiments using drop tensiometry.

Based on the experimental results discussed above, a concentration of 4.0 wt. % PGPR was used for certain emulsions prepared in Example 2, below.

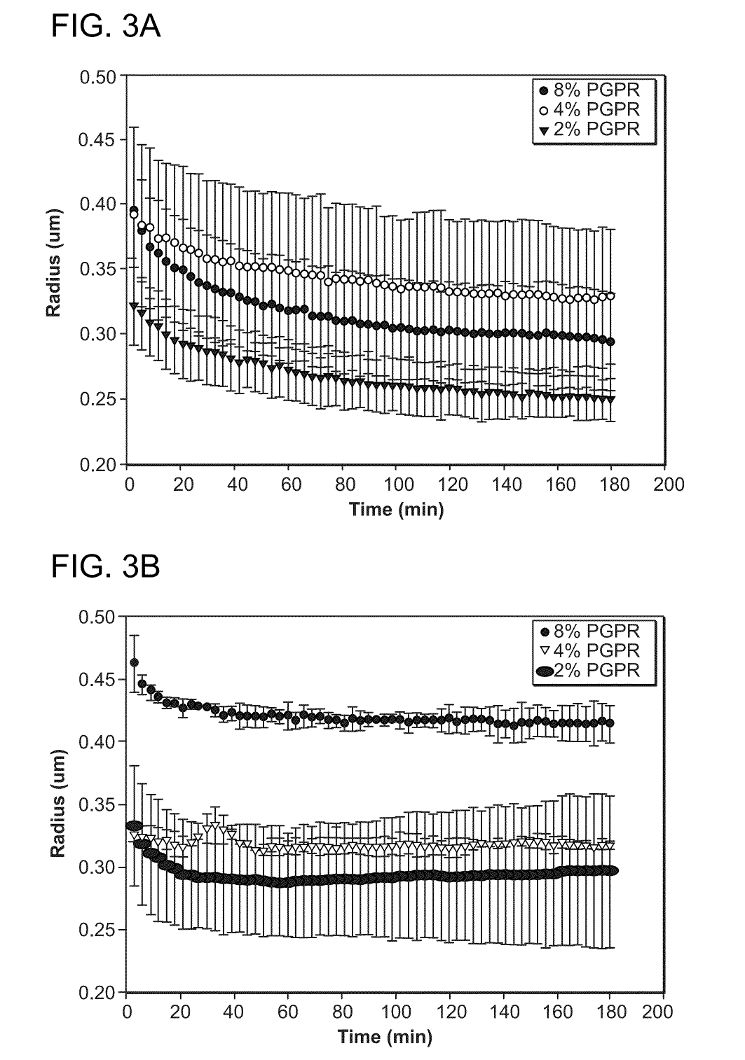

Part 2. Gelation of the water droplets. The gelation of water droplets, i.e., of the aqueous core of certain exemplary embodiments of the emulsions disclosed here, was investigated by development of two systems, one containing low methoxyl pectin (LMP, about 35% DE) and the second containing high methoxyl pectin (HMP, about 70% DE). The formation of calcium-induced gels was evaluated using a 0.5% LMP solution and by addition of CaCO₃ and 1% glucono delta-lactone (GDL), both added directly to the pectin solution, adjusted to pH 5. GDL slow hydrolysis caused a gradual decrease of the pH of the aqueous core mixture, causing solubilization of calcium and inducing gelation. The mixture was kept under constant stirring to prevent sedimentation of CaCO3 and GDL and the formation of unhomogeneous gels. FIG. 3 shows the difference in apparent radius measured by diffusing wave spectroscopy (“DWS”) for the 30% water in oil emulsions prepared with 0.5% LMP and the different amounts of PGPR, and either gelled (Graph A in FIG. 3) or not gelled (Graph B in FIG. 3). All emulsions showed to be stable with an average radius of about 350 nm. The values shown are the average of three replicates, with bars indicating standard deviation.

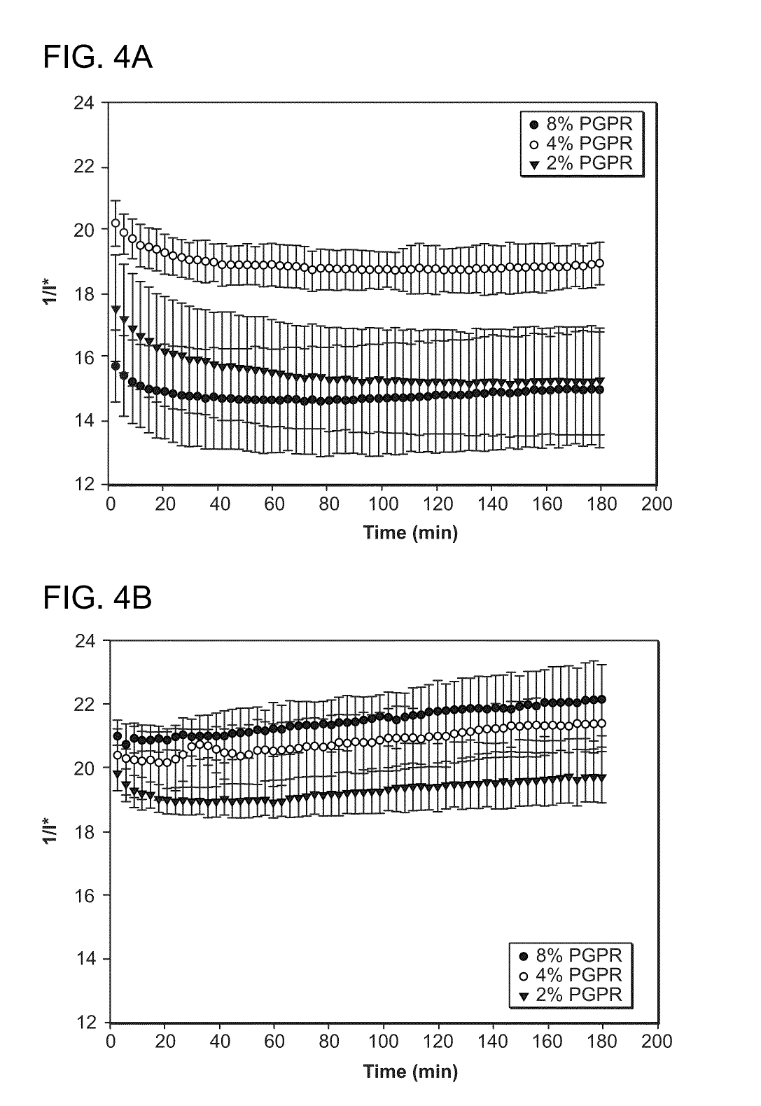

When analyzing the emulsions using DWS, in addition to observing the dynamics of particles' motion (from which the particle radius is calculated), it is also possible to measure a turbidity parameter (1/1*) which is an indication of the optical properties of the emulsions. The values of 1/1* as a function of time for the emulsions, gelled and non-gelled are shown in FIG. 4. There was a different trend in the turbidity parameter of the water in oil emulsions as a function of concentration of PGPR, depending on whether the emulsions had a gelled core (Graph A of FIG. 4) or a non-gelled core (Graph B of FIG. 4). The gelled particles showed a lower turbidity value than the particles with a non-gelled core. However, apart from a slight change in the turbidity parameter, there were no substantial differences between these two emulsion systems.

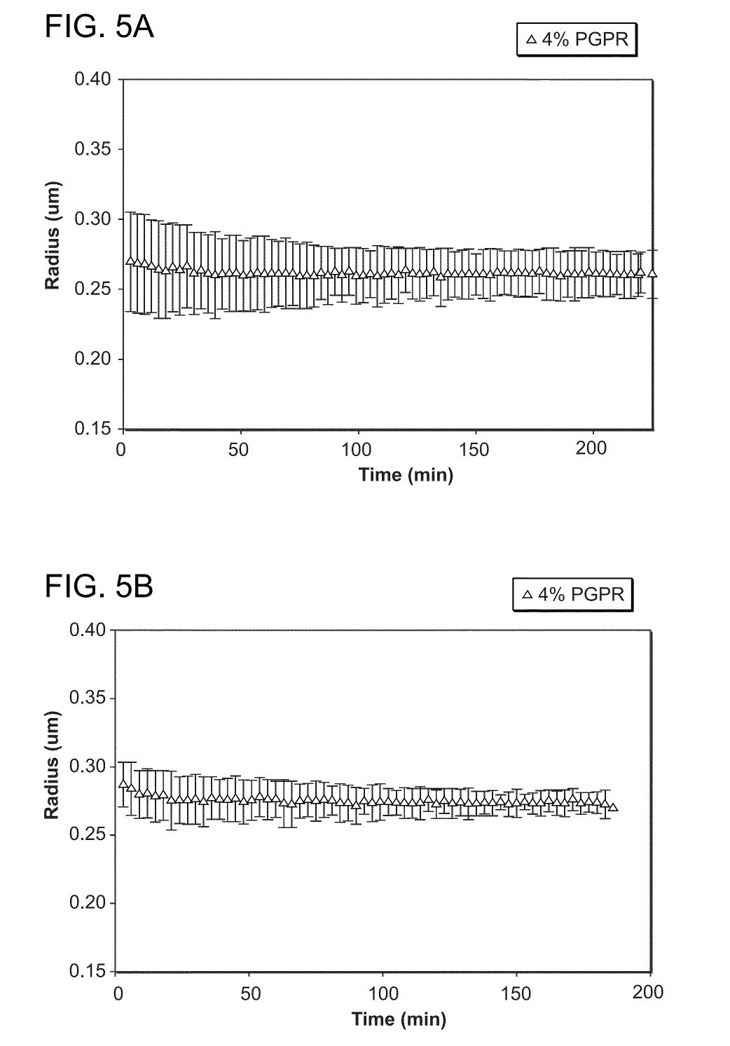

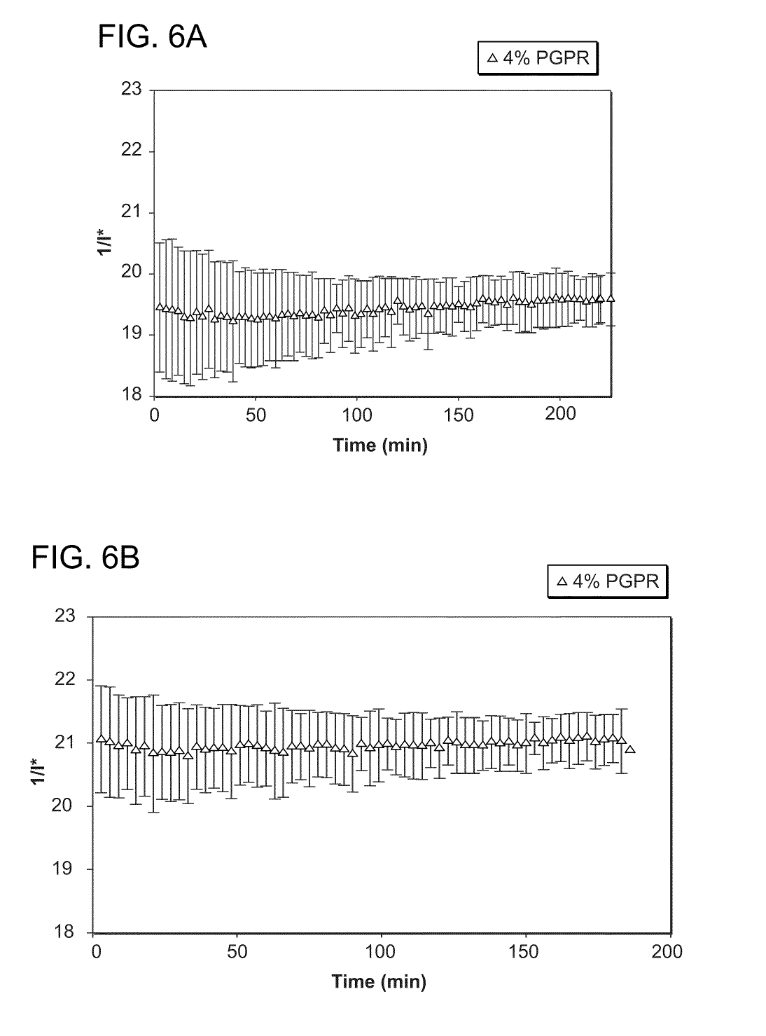

Example 2. Gelation of water droplets with HMP. An emulsion was prepared and tested as above except that 1.0 wt. % HMP (70% DE) was used and gelation was induced by the addition of pectin methyl esterase (PME). This enzyme cleaves methylated esters of galacturonic acid creating a higher number of negative charges. It is believed in that the presence of calcium, HMP is then converted to a calcium sensitive pectin, and gels form. FIG. 5 shows the apparent radius of the HMP emulsions of this example as a function of time. In this case, both gelled and non-gelled water droplets showed an apparent radius of 280 nm. In this case also, the turbidity parameter of the water in oil emulsion was lower in the gelled than the non-gelled droplets (FIG. 6). Without wishing to be bound by theory, it is hypothesized that the differences in the refractive index between the gelled and the non-gelled particles are responsible for the differences in the optical properties (turbidity parameter).

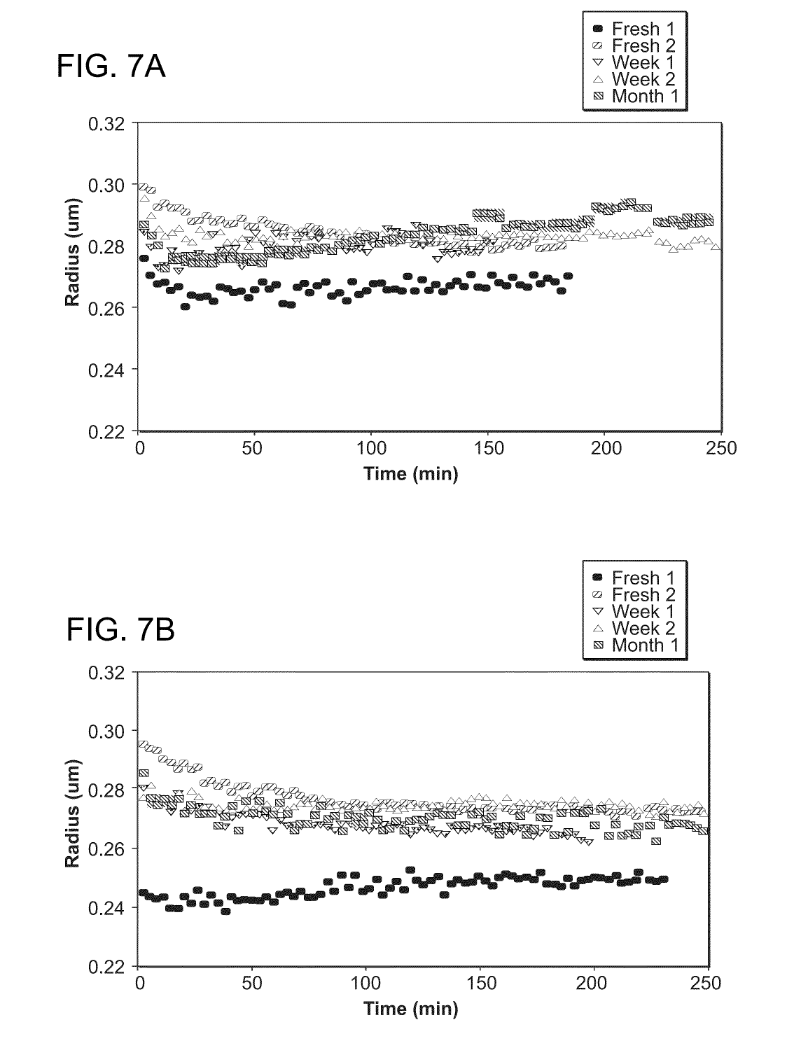

The water in oil emulsions prepared were stable during storage. The apparent radius of the emulsions of Example 2 containing HMP, measured after 1 month of storage, is shown in FIG. 7 for gelled and non-gelled systems. It was concluded that gelation of the interior of the emulsion droplet did not affect the size of the droplets, and that, although the optical properties changed (the turbidity parameter seemed to decrease with the gelled particles), gelation did not show large differences from the original water droplets without a gelled core. This was generally the case for the droplets emulsified with 2% and 4% PGPR, while the emulsions prepared with 8% PGPR were affected by the gelation, as the gelled and the non-gelled emulsions were smaller in the gelled systems. In addition, the primary emulsions showed no aggregation after one month of storage.

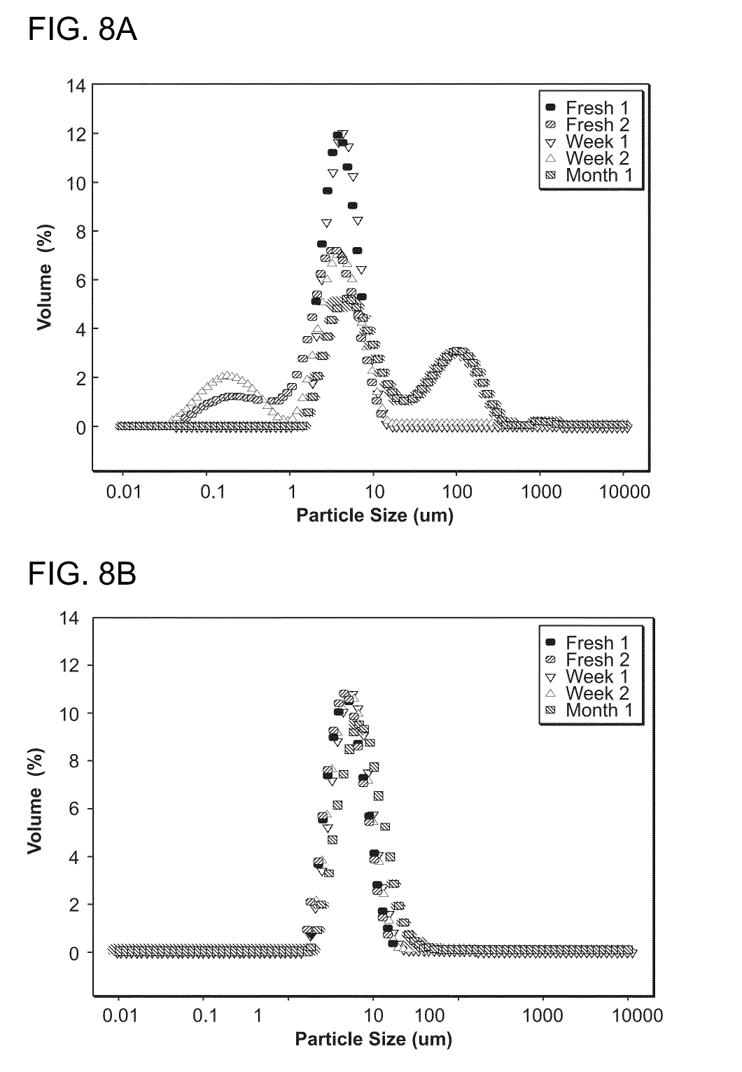

Example 3. Formation of water in oil in water droplets. Water in oil emulsions (30 wt. % water in oil) were prepared using 1.0 wt. % HMP and having gelled aqueous cores, as described above in Example 2. After preparation of the water-in-oil primary emulsions, they were used to prepare secondary emulsions containing 10% oil and 90% aqueous phase and containing 0.5% sodium caseinate, passing twice through a homogenizer using low pressure (250 psi). Magnesium chloride was used to test the gel system for incorporation of cations. Cations were expected to interact strongly with the pectin gels. In addition, Erioglaucine (brilliant blue) was used to quantify the release of the inner droplets in the outer water phase over time. Erioglaucine is a water soluble dye, easily measured with UV/VIS. Particle size distribution, encapsulation efficiency and microstructure of the emulsions were tested. FIG. 8 illustrates the particle size distribution of the double emulsions (i.e., of the W-O-W systems) of this example, measured with a Mastersizer (available from Malvern Instruments Ltd.), with gelled or non-gelled inner core. It is clear that in both cases, the nanoparticles of the secondary emulsions showed to be about 10 μm in diameter, and there were differences in their stability over storage time, with more variation in the particle size for the oil droplets containing a gelled core.

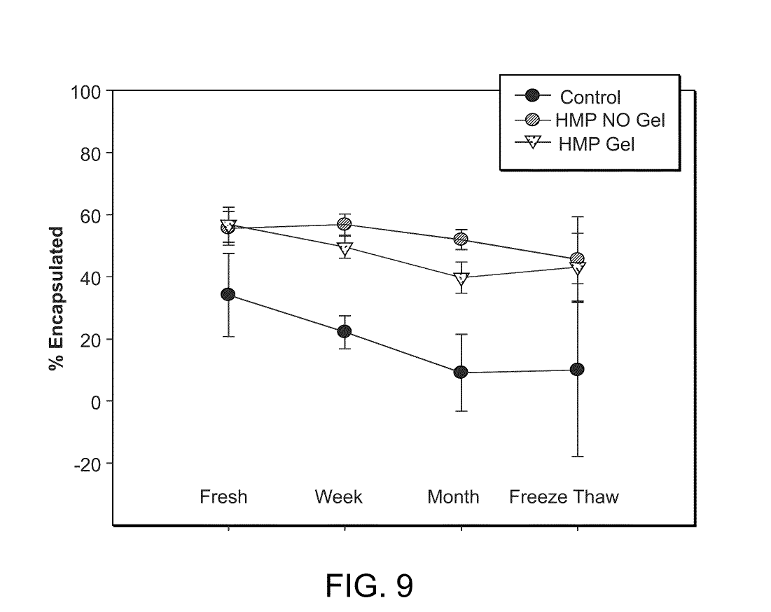

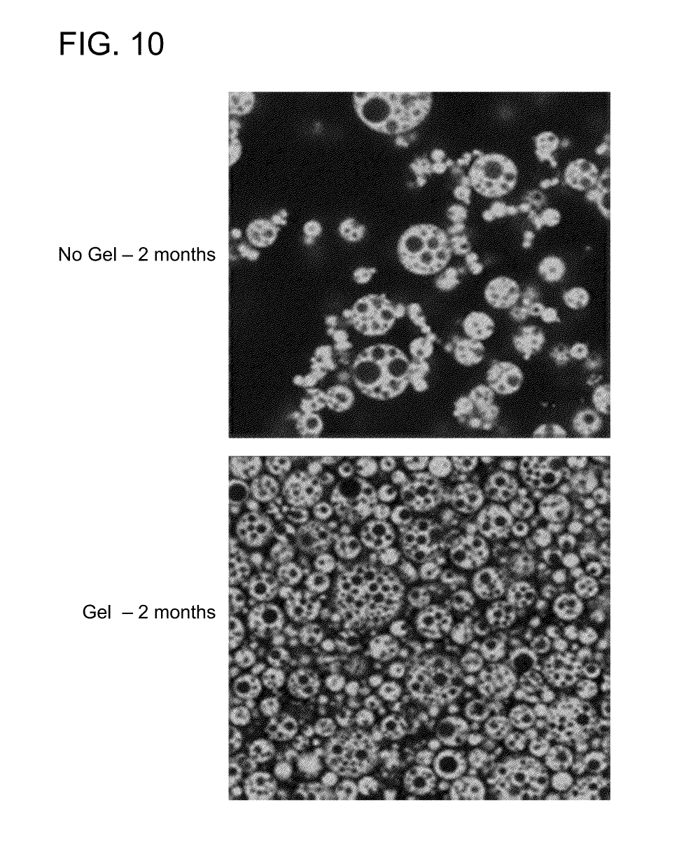

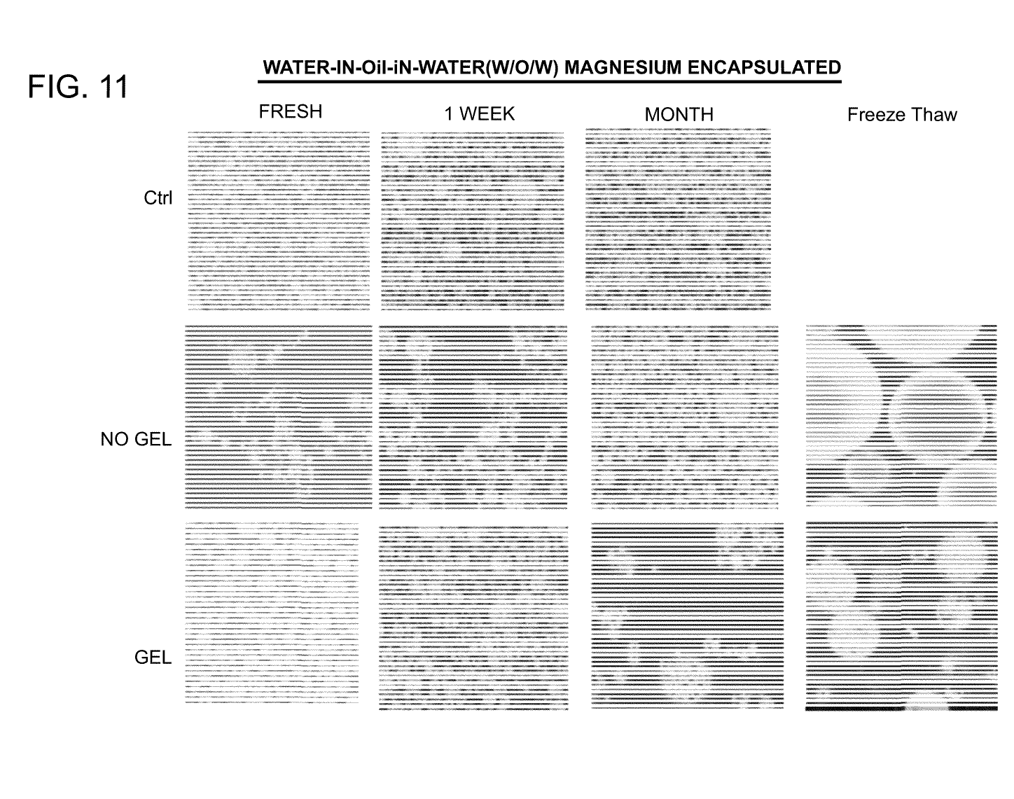

The encapsulation was measured as the ratio between the residual amount in the droplets (initial-released in the external water phase) and the initial amount encapsulated. This value was measured initially (giving an indication of the encapsulation efficiency) as well as during storage. The results seen in FIG. 9 clearly demonstrate that the presence of HMP in the inner droplets significantly improved encapsulation efficiency of brilliant blue, and that in this tested embodiment gelation of the inner droplets provided similar results without further improvement of the efficiency. Similar results were also shown for emulsions containing HMP and magnesium chloride. Table 1, below, summarizes the results of the encapsulation measurements for magnesium. The amount of magnesium in the water phase was determined using ion chromatography. A high amount of magnesium (>80%) was still encapsulated after one month of storage. The microstructure of the water-in-water (w/o/w or secondary) emulsions containing magnesium chloride was analyzed using confocal microscopy, and the results are shown in FIGS. 10 and 11. Nile red was used as a preferential stain for the lipid phase. Images were taken at various times during storage and after one freeze thaw cycle for both gelled and non-gelled inner droplets.

Creaming occurred in the secondary emulsions within a few hours—and the particle size of the emulsions was different depending on the presence or absence of a gelled inner core. Confocal microscopy demonstrated good stability and retention of interior droplets in both gelled and non-gelled systems. There appeared to be better stability in the gelled emulsions after freeze thaw. Encapsulation data for Brilliant Blue indicates good retention of dye in both systems with more dye being released with time. The presence of pectin improves incorporation compared with control systems with no pectin.

TABLE 1
Amount of magnesium encapsulated in and released from
the inner droplets of W-O-W secondary emulsions, in
fresh emulsions and after storage for samples with
1% HMP, 4% PGPR, and 0.5% sodium caseinate

| | Percent | Percent |
|---|---|---|
| Sample | Released | Encapsulated |
| Fresh No Gel 1 | 6.1 | 93.8 |
| Fresh No Gel 2 | 7.2 | 92.8 |
| Week - No Gel 1 | 9.1 | 90.9 |
| Week - No Gel 2 | 11.3 | 88.7 |
| Fresh Gel 1 | 8.2 | 91.8 |
| Fresh Gel 2 | 12.7 | 87.3 |
| Week - Gel 1 | 18.2 | 87.3 |
| Week - Gel 2 | 18.2 | 81.8 |
| Month - No Gel 1 | 15.0 | 84.9 |
| Month - Gel 1 | 19.1 | 80.9 |

The invention has been described with reference to the preferred embodiments. Modifications and alterations will occur to others upon reading and understanding the preceding detailed description. It is intended that the invention be construed as including all such modifications and alterations insofar as they come within the scope of the appended claims or the equivalents thereof.

What is claimed is:

1. An edible, water-in-oil type emulsion of emulsion particles comprising a gelled core in a hydrophobic shell, wherein:
the gelled core comprises:
aqueous gel of cation-bridged pectin;
at least one functional hydrophilic substance in the aqueous gel, the functional hydrophilic substance being a water miscible substance, water soluble substance, or a mixtures of any of them; and
pectinase; and
the hydrophobic shell comprising:
at least one hydrophobic material, and
an emulsifier.

2. An edible, water-in-oil type emulsion of emulsion particles comprising a gelled core in a hydrophobic shell, wherein:
the gelled core comprises:
aqueous gel of calcium-bonded pectin;
at least one functional hydrophilic substance in the aqueous gel, the functional hydrophilic substance being a water miscible substance, water soluble substance, or a mixtures of any of them; and
pectinase; and
the hydrophobic shell comprising:
at least one hydrophobic material, and
an emulsifier.

3. The edible water-in-oil type emulsion of claim 2 wherein the pectinase comprises pectin methyl esterase.

4. The edible water-in-oil type emulsion of claim 2 wherein the at least one functional hydrophilic substance is heat-sensitive hydrophilic substance.

5. The edible water-in-oil type emulsion of claim 2 wherein the at least one functional hydrophilic substance comprises a hydrophilic nutritional ingredient.

6. The edible water-in-oil type emulsion of claim 2 wherein the hydrophobic material comprises edible oil.

7. The edible water-in-oil type emulsion of claim 6 wherein the edible oil consists essentially of soybean oil.

8. The edible water-in-oil type emulsion of claim 2 further comprising at least one additional ingredient selected from antioxidants, stabilizers, and combinations of any of them.

9. A beverage comprising:
water;
an edible emulsion of water-in-oil type emulsion particles dispersed in the water, the emulsion particles comprising a gelled core in a hydrophobic shell, wherein:
the gelled core comprises:
aqueous gel of cation-bridged pectin;
at least one functional hydrophilic substance in the aqueous gel, the functional hydrophilic substance being a water miscible substance, water soluble substance, or a mixtures of any of them; and
pectinase enzyme; and
the hydrophobic shell comprising:
at least one hydrophobic material, and
an emulsifier; and
at least one additional beverage ingredient.

10. The edible water-in-oil type emulsion of claim 9 wherein the aqueous gel of cation-bridged pectin comprises aqueous gel of calcium-bonded pectin.

11. The edible water-in-oil type emulsion of claim 9 wherein the pectinase enzyme comprises pectin methyl esterase.

12. The edible water-in-oil type emulsion of claim 9 wherein the at least one functional hydrophilic substance is not stable above 100° F.

13. The beverage of claim 9 wherein the at least one functional hydrophilic substance comprises a nutritional hydrophilic substance or a colorant for the beverage.

14. The beverage of claim 9 wherein the at least one functional hydrophilic substance comprises a water-soluble or miscible nutritional substance selected from vitamins, sterols, flavonoids, minerals, extracts from plants, herbs, DNA, amino acids, organic compounds and a combination of any of them.

15. The beverage of claim 9 wherein the at least one additional beverage ingredient is selected from additional nutritional ingredients, antioxidants, stabilizers, flavour ingredients, colorants, acidulants, preservatives, clouding agents, carbonation, taste masking or modifying agents, sweeteners, or a combination of any of them.

16. A method of making an edible emulsion of water-in-oil type emulsion particles comprising the steps of:
providing an aqueous core mixture comprising:
water;
at least one functional hydrophilic substance selected from water miscible substances, water soluble materials, and mixtures of any of them;
pectin;
an edible source of multivalent cations; and
pectinase;
providing an oil phase comprising:
at least one hydrophobic material, and
an emulsifier;
forming an emulsion comprising particles having an aqueous core in a hydrophobic shell, comprising:
combining the aqueous core mixture with the oil phase to form an emulsion mixture, and
emulsifying the emulsion mixture; and
gelling the aqueous core, comprising formation of ion-bridged pectin in the core at least partly following the forming of the emulsion.

17. The method of making an edible emulsion according to claim 16 wherein the step of gelling the aqueous core is performed without adding heat to the emulsion mixture.

18. The method of making an edible emulsion according to claim 16, wherein the source of multivalent cations comprises a source of calcium cations, zinc cations, magnesium cations, divalent or trivalent iron cations, or a combination of any of them.

19. The method of making an edible emulsion according to claim 16, wherein the source of multivalent cations comprises a source of divalent calcium ions in the aqueous core mixture.

20. The method of making an edible emulsion according to claim 16, wherein the source of multivalent cations comprises CaCO₃.

21. The method of making an edible emulsion according to claim 16, wherein the pectin comprises low methoxyl pectin, high methoxyl pectin or a combination of any of them.

22. The method of making an edible emulsion according to claim 16, wherein the pectin has a DE value of from 35% to 70%.

23. The method of making an edible emulsion according to claim 16, wherein gelling of the encapsulated aqueous core mixture is at least partially induced by enzyme cleavage of methylated esters of galacturonic acid of the pectin by the pectinase at least in part after forming the emulsion.

24. The method of making an edible emulsion according to claim 16, wherein forming the emulsion comprises high pressure homogenization of the emulsion mixture.

25. The method of making an edible emulsion according to claim 16, wherein the hydrophobic material comprises edible vegetable oil and the emulsifier comprises polyglycerol polyricinoleate (PGPR) at a concentration between 1.0 wt. % and 10.0 wt. %.

26. The method of making an edible emulsion according to claim 25, wherein the edible vegetable oil is selected from soybean oil, palm oil, coconut oil, sunflower oil, safflower oil, and a combination of any of them.

27. A method of making an aqueous dispersion of an edible emulsion, comprising the steps of:
providing an aqueous core mixture comprising:
water;
at least one functional hydrophilic substance selected from water miscible substances, water soluble materials, and mixtures of any of them;
pectin;
an edible source of multivalent cations; and
pectinase;
providing an oil phase comprising:
at least one hydrophobic material, and
an emulsifier;
forming an emulsion comprising particles having an aqueous core in a hydrophobic shell, comprising:
combining the aqueous core mixture with the oil phase to form an emulsion mixture, and
emulsifying the emulsion mixture;
gelling the aqueous core, comprising formation of calcium-bonded pectin in the core at least partly following the forming of the emulsion; and
dispersing the emulsion in an aqueous liquid.
